(19) United States
(12) Patent Application Publication
(10) Pub. No.: US 2026/0118659 A1
(43) Pub. Date: Apr. 30, 2026

(54) OPTICAL SCANNING DEVICE AND IMAGE FORMING APPARATUS

(71) Applicant: Sharp Kabushiki Kaisha, Sakai City (JP)

(72) Inventors: Kenzo OHKUBO, Sakai City (JP); Hidenori SATO, Sakai City (JP); Hiroshi YAMAMOTO, Sakai City (JP); Akito TERAMOTO, Sakai City (JP)

(21) Appl. No.: 19/363,790

(22) Filed: Oct. 21, 2025

(30) Foreign Application Priority Data
Oct. 31, 2024 (JP) 2024-192221

(51) Int. Cl. G02B 26/12; B41J 2/44; B41J 2/47; G03G 15/04; G03G 15/043

(52) U.S. Cl. CPC G02B 26/125; B41J 2/442; B41J 2/471; G03G 15/04045; G03G 15/0435

(57) ABSTRACT

The optical scanning device comprises a semiconductor laser, which serves as a light source for exposing the surface of the photosensitive body; a polygon mirror, which deflects the light from the semiconductor laser in the main scanning direction; and a cylindrical lens, which is positioned between the semiconductor laser and the polygon mirror and deflects the light from the semiconductor laser in the sub-scanning direction to irradiate the polygon mirror.

The cylindrical lens includes an incident surface, through which light from the semiconductor laser enters, and an exit surface, through which the incident light exits. The curvature direction of the incident surface in the main scanning direction and the curvature direction of the exit surface in the main scanning direction are formed to be different from each other.

### CROSS-REFERENCE TO RELATED APPLICATION

The present application claims priority from Japanese Application JP2024-192221, the content of which is hereby incorporated by reference into this application.

### BACKGROUND OF THE INVENTION

### 1. Field of the Invention

The disclosure relates to an optical scanning device and an image forming apparatus.

### 2. Description of the Related Art

In the related art, in an optical scanning device (Laser Scanner Unit (LSU)) of an image forming apparatus, a cylindrical lens is changed from glass to resin for cost reduction. In such an optical scanning device, an incident surface of the cylindrical lens is configured to form in a straight line so as not to protrude from the incident surface side of an effective region of the cylindrical lens, and an exit surface side of each non-lens region is configured so as not to protrude from the exit surface side of the effective region of the cylindrical lens by convexly curving the exit surface.

In the optical scanning device of the image forming apparatus in the related art, the image forming apparatus in which the cylindrical lens is made of resin for cost reduction is configured as described above. On the other hand, there is a problem that accuracy varied greatly in the resin lens and variations occurred in a main scanning depth at a stage of adjusting the cylindrical lens after incident light was adjusted.

### SUMMARY OF THE INVENTION

The disclosure has been made to solve the above-described problem, and an object of the disclosure is to provide an image forming apparatus including an optical scanning device in which a main scanning depth is stabilized at a stage of adjusting a cylindrical lens.

An optical scanning device according to the disclosure includes a light source that exposes a surface of a photoreceptor, a polygon mirror that deflects light from the light source in a main scanning direction, and a cylindrical lens that is disposed between the light source and the polygon mirror, deflects the light from the light source in a sub-scanning direction, and irradiates the polygon mirror wherein the cylindrical lens includes an incident surface on which the light from the light source is incident and an exit surface from which the light incident on the incident surface exits, and a curvature direction in the main scanning direction of the incident surface and a curvature direction in the main scanning direction of the exit surface are formed to be directions different from each other.

The curvature direction in the main scanning direction of the incident surface may be a convex direction of the cylindrical lens, and the curvature direction in the main scanning direction of the exit surface may be the convex direction of the cylindrical lens, and the curvature direction in the main scanning direction of the incident surface may be a concave direction of the cylindrical lens, and the curvature direction in the main scanning direction of the exit surface may be the concave direction of the cylindrical lens.

More preferably, the cylindrical lens is formed of resin.

In another aspect of the disclosure, the image forming apparatus includes any one of the optical scanning devices described above.

According to the disclosure, the curvature direction in the main scanning direction of the incident surface of the cylindrical lens and the curvature direction in the main scanning direction of the exit surface are set to be the directions different from each other to control such that variations in a molded shape of the cylindrical lens to be in a certain direction.

As a result, it is possible to provide a main scanning apparatus and an image forming apparatus in which a main scanning depth is stabilized at a stage of adjusting a cylindrical lens.

The above-described objects, other objects, features, and advantages of the present disclosure will be further obvious from the detailed description of examples given below with reference to the drawings.

### BRIEF DESCRIPTION OF THE DRAWINGS

FIG. 1 is a perspective view illustrating an optical scanning device of an image forming apparatus according to an embodiment of the disclosure.

FIG. 2 is a plan view illustrating the optical scanning device of the image forming apparatus according to the embodiment of the disclosure.

FIG. 3 is a perspective view illustrating a vicinity of a cylindrical lens of the optical scanning device illustrated in FIG. 1.

FIG. 4 includes diagrams each showing a cross-sectional shape in a main scanning direction of a cylindrical lens molded with resin.

### DETAILED DESCRIPTION OF THE INVENTION

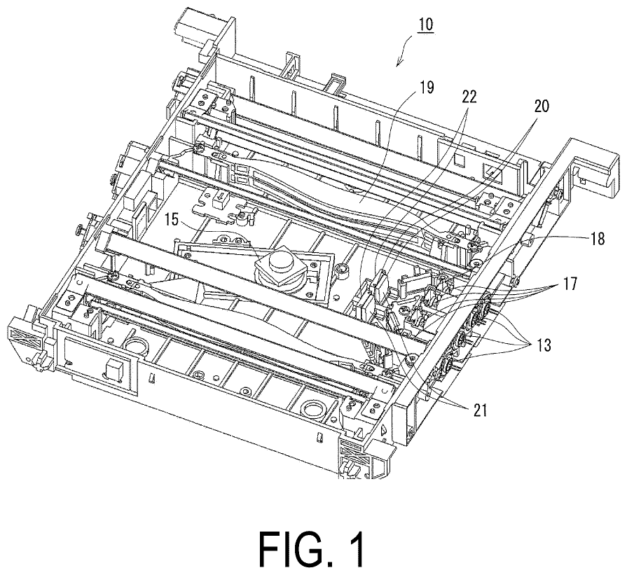

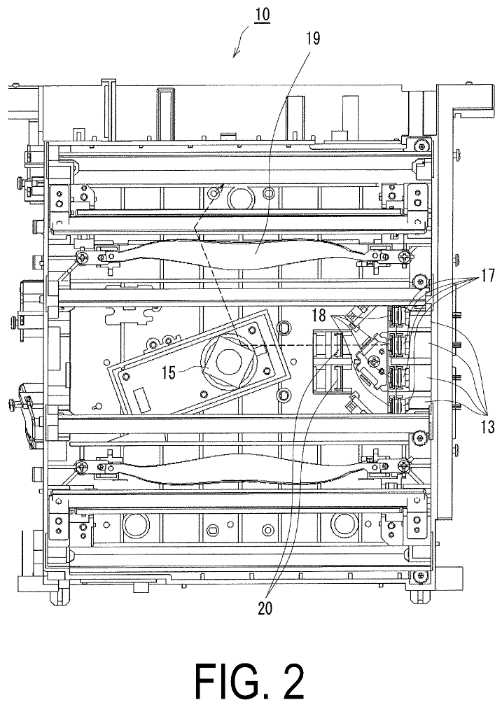

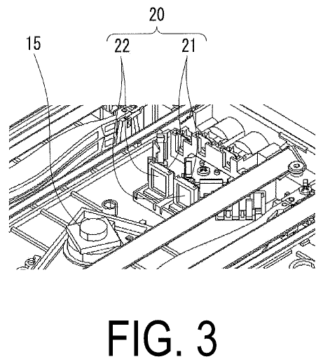

An embodiment of the disclosure will be described in detail below with reference to the drawings. FIG. 1 is a perspective view illustrating an optical scanning device of an image forming apparatus according to the embodiment of the disclosure, FIG. 2 is a plan view illustrating the optical scanning device of the image forming apparatus according to the embodiment of the disclosure, and FIG. 3 is a perspective view illustrating a vicinity of a cylindrical lens of the optical scanning device illustrated in FIG. 1.

Referring to FIGS. 1 to 3, an optical scanning device 10 includes a semiconductor laser 13 that is a light source that exposes a surface of a photoreceptor (not illustrated), a polygon mirror 15 that deflects light from the semiconductor laser 13 in a main scanning direction, and a cylindrical lens 20 that is disposed between the semiconductor laser 13 and the polygon mirror 15, deflects the light from the semiconductor laser 13 in a sub-scanning direction, and irradiates the polygon mirror 15. The cylindrical lens 20 is a lens having a convex shape in only one direction, and includes an incident surface 21 on which the light from the semiconductor laser 13 is incident and an exit surface 22 from which the incident light exits.

Here, four of the semiconductor lasers 13 are provided so as to correspond to respective colors of YMCK, and the light from the semiconductor laser 13 is collimated by collimator lens 17, unnecessary light is removed by a slit 18, and the light is condensed at a photoreceptor (not illustrated) by the cylindrical lens 20 being a convex lens via the polygon mirror 15 and an fθ lens 19, thereby writing data. Note that in FIG. 2, a path is indicated by a dotted line, in which light from one semiconductor laser 13 is collimated by the collimator lens 17, unnecessary light is removed by the slit 18, and the light is guided to the photoreceptor (not illustrated) via the cylindrical lens 20, and through the polygon mirror 15 and the fθ lens 19. As illustrated in FIG. 1, the light is deflected by a mirror (not illustrated) after passing through the fθ lens 19.

The polygon mirror 15 is rotated by a polygon motor provided at a lower portion thereof, and scans the light from the semiconductor laser 13. Here, a point on the polygon mirror 15 and a point on the photoreceptor are arranged so as to have a conjugate relationship, thereby providing a configuration in which even when a rotation shaft of the polygon motor is slightly inclined, influence thereof does not appear on the photoreceptor.

The cylindrical lens 20 has a curvature only in a vertical direction on the incident surface 21 side, and the exit surface 22 side is flat.

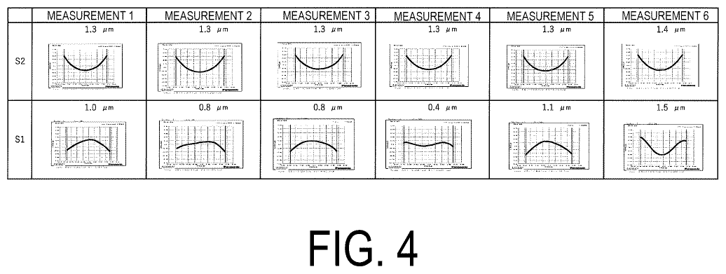

FIG. 4 includes diagrams each showing a cross-sectional shape in the main scanning direction of the cylindrical lens 20 molded with resin. A role of the cylindrical lens 20 is to condense light in the sub-scanning direction. Note that light is passed through as is in the main scanning direction. The cylindrical lens 20 molded with resin has variations in a shape thereof. A reason why the variations are troublesome is that, when deviation occurs in the vertical direction, deviation in the main scanning direction cannot be adjusted.

Here, the curvature of the cylindrical lens 20 was measured by a device for measuring the curvature of the cylindrical lens 20. Cross-sectional shapes of the cylindrical lens 20 in the main scanning direction include S1 on the incident surface 21 side near the semiconductor laser 13 and S2 on the exit surface 22 side near the polygon mirror 15. Originally, when the cross-sectional shape in the main scanning direction is flat, the cross-section is a plane as designed, but a resin lens is molded in a mold, thus an uneven shape is likely to occur due to heat at the time of resin curing, variations in a degree of curing, and the like. In general, it is difficult to flatten the resin lens molded in a mold at the time of molding, but it is possible to induce molding so that the resin lens has either a concave shape or a convex shape after molding, although there are slight variations.

Referring to FIG. 4, six measurement results of Measurement 1 to Measurement 6 are shown as the cross-sectional shapes of the cylindrical lens 20 in the main scanning direction. S2 being the exit surface 22 side has an identical concave curve shape in Measurements 1 to 6, and thus the shape is stable, but a shape of S1 being the incident surface 21 side of the cylindrical lens 20 changes for each measurement and is unstable.

Next, each measurement will be described. First, referring to Measurement 1, a curvature direction in the main scanning direction of S1 on the incident surface 21 side is a convex direction, a curvature direction in the main scanning direction of S2 on the exit surface 22 side is a concave direction, and the curvature direction in the main scanning direction of S1 on the incident surface 21 side and the curvature direction in the main scanning direction of S2 on the exit surface 22 side are formed to be directions different from each other. When a curved shape is concave, f (a focal length) is long, and when a curved shape is convex, f (a focal length) is short, and these curved shapes cancel each other, so that a distance to the photoreceptor (not illustrated) can be adjusted.

Referring to Measurements 2, 3, and 5, convex shapes of S1 are more distorted as compared to Measurement 1, but are still convex shapes.

Referring to Measurement 4, S1 has two portions of a convex shape. With such a shape, a beam spot on the photoreceptor is not substantially circular. Referring to Measurement 6, since S1 also has a concave shape, a position in a predetermined direction of a beam spot on the photoreceptor is shifted to a position in the sub-scanning direction. Both cases are not preferable because image quality is affected.

Therefore, as far as the shape of S1 on the incident surface 21 side is a convex shape as in Measurements 1 to 3 and 5, a concave shape of S2 on the exit surface 22 side can be used to cause distortions of the incident surface and the exit surface of the cylindrical lens 20 to appear in directions so as to cancel each other, thereby controlling variations in a molded shape of the cylindrical lens 20 to be in a certain direction. To be specific, molding can be induced such that variations in a molded shape of each of S1 on the incident surface 21 side and S2 on the exit surface 22 side result in either a concave shape or a convex shape.

### First Embodiment

Next, the shape of the resin lens for obtaining such a shape will be described. With a concave shape of S2 on the exit surface 22 side illustrated in Measurement 1 in FIG. 4, the air is above and the resin lens is below. Therefore, the curvature direction in the main scanning direction of the exit surface of the resin lens is a concave direction of the cylindrical lens. On the other hand, in a convex shape of S1 on the incident surface 21 side, the resin is above and the air is below. Therefore, the curvature direction in the main scanning direction of the incident surface of the resin lens is a concave direction of the cylindrical lens.

### Second Embodiment

Here, the case where S1 on the incident surface 21 side and S2 on the exit surface 22 side have an identical concave shape has been described, but the same applies to a case where both S1 on the incident surface 21 side and S2 on the exit surface 22 side have an identical convex shape.

As described above, in the disclosure, the curvature direction of S1 in the main scanning direction of the incident surface and the curvature direction of S2 in the main scanning direction of the exit surface were formed to be the directions different from each other, and thus a distance from the semiconductor laser to the photoreceptor (not illustrated) was adjusted so that a main scanning depth was stable even when distortion occurred in the resin lens.

Here, the main scanning depth will be described. The main scanning depth means a degree of spread of a beam diameter necessary for forming a beam having a predetermined diameter of the semiconductor laser 13 on the photoreceptor. It can be said that variations in the main scanning depth are smaller as the smaller degree of the spread of the beam diameter.

### Third Embodiment

Although the variations in distortion in the main scanning direction of the resin lens have been described above, the same applies to the sub-scanning direction. The distortion in the sub-scanning direction appears as a shift in the sub-scanning direction of a beam spot of the semiconductor laser 13 formed at a predetermined position on the photoreceptor.

The cylindrical lens is formed such that the incident surface 21 side convexly curves in the sub-scanning direction and the exit surface 22 side is a plane in the sub-scanning direction, but when distortions generated on the respective surfaces cancel each other, the deviation in the sub-scanning direction is not affected so much.

That is, it is sufficient that when the distortion in the sub-scanning direction on the exit surface 22 side is concave, the distortion in the sub-scanning direction on the incident surface is also concave. Here, since the incident surface 21 side in the sub-scanning direction is formed in a convex shape originally, when the distortion in a concave shape occurs, a degree of curvature forming a convex shape on the incident surface 21 side becomes gentle (slightly closer to a flat surface).

As described above, in the disclosure, the curvature direction in the sub-scanning direction of the incident surface and the curvature direction in the sub-scanning direction of the exit surface are formed to be directions different from each other, and thus, even when distortion occurs in the resin lens, a position of a beam spot formed on the photoreceptor is stabilized.

In the disclosure, distortions in the incident surface 21 and the exit surface 22 of the cylindrical lens 20 made of resin are made to appear in mutually canceling directions, to control such the variations in the molded shape of the cylindrical lens 20 to be in a certain direction, thereby suppressing and stabilizing the variations in the main scanning depth at the stage of adjusting the cylindrical lens 20.

In the above embodiments, the case where the cylindrical lens is molded with resin has been described, but the disclosure is not limited thereto, and the above embodiments may be applied to a case where a cylindrical lens is molded with glass or the like.

The disclosure may be carried out in other various forms without departing from the spirit or essential characteristics thereof. Thus, the above-described embodiments are merely examples and should not be interpreted as limiting. All modifications and changes equivalent in scope with the claims of the disclosure are included in the scope of the disclosure.

According to the disclosure, an image forming apparatus including an optical scanning device with a stable main scanning depth can be provided, and thus the disclosure is useful as an image forming apparatus.

What is claimed is:

1. An optical scanning device comprising:
a light source that exposes a surface of a photoreceptor;
a polygon mirror that deflects light from the light source in a main scanning direction; and
a cylindrical lens that is disposed between the light source and the polygon mirror, deflects the light from the light source in a sub-scanning direction, and irradiates the polygon mirror wherein
the cylindrical lens includes an incident surface on which the light from the light source is incident and an exit surface from which the light incident on the incident surface exits, and
a curvature direction in the main scanning direction of the incident surface and a curvature direction in the main scanning direction of the exit surface are formed to be directions different from each other.

2. The optical scanning device according to claim 1, wherein
a curved direction in the main scanning direction of the incident surface is a convex direction of the cylindrical lens, and a curvature direction in the main scanning direction of the exit surface is a convex direction of the cylindrical lens.

3. The optical scanning device according to claim 1, wherein
a curved direction in the main scanning direction of the incident surface is a concave direction of the cylindrical lens, and a curvature direction in the main scanning direction of the exit surface is a concave direction of the cylindrical lens.

4. The optical scanning device according to claim 1, wherein
the cylindrical lens is formed of resin.

5. An image forming apparatus comprising:
the optical scanning device according to claim 1.
